(19) United States
(12) Patent Application Publication
(10) Pub. No.: US 2025/0141382 A1
(43) Pub. Date: May 1, 2025

(54) FIELD ORIENTED CONTROL WITH SECTOR DETERMINATION

(71) Applicant: Texas Instruments Incorporated, Dallas, TX (US)

(72) Inventor: Alexander Tessarolo, Lindfield (AU)

(21) Appl. No.: 18/615,202

(22) Filed: Mar. 25, 2024

Related U.S. Application Data
(60) Provisional application No. 63/546,860, filed on Nov. 1, 2023.

(51) Int. Cl. H02P 21/34; H02P 21/00; H02P 21/10

(52) U.S. Cl. CPC H02P 21/34; H02P 21/0017; H02P 21/10

(57) ABSTRACT

In described examples, a device includes a non-transitory memory and a processor. The memory stores a first instruction. The processor receives the first instruction from the memory. Executing the first instruction causes the processor to perform the following actions. The processor receives a position vector corresponding to a sum of a first component in a first dimension and a second component in a second dimension. The processor compares a magnitude of the first component to a magnitude of the second component, and compares the first component or the second component to zero. And the processor determines a sector in which the position vector is located responsive to the compare actions and a sector layout. In some examples, execution of additional instructions causes the processor to operate a rotational system in response to the determined sector.

### CROSS-REFERENCE TO RELATED APPLICATION

This application claims the benefit of and priority to U.S. Provisional Application No. 63/546,860, filed Nov. 1, 2023, which is incorporated herein by reference

### TECHNICAL FIELD

This application relates generally to field oriented control (FOC), for example for motors, and more particularly to determining control vectors for rotational systems using FOC.

### BACKGROUND

In some examples, a motor is a permanent magnet motor or induction motor. In some examples, a permanent magnet motor or induction motor includes a fixed stator that causes rotation of a movable rotor. For permanent magnet motors, the rotor includes multiple magnets embedded in or connected to the rotor. For induction motors, the rotor includes multiple conductive windings embedded or connected to the rotor. The stator includes multiple conductive windings. Electrical signals through the windings generate a rotating magnetic field that interacts with the magnets or conductive windings of the rotor, causing the rotor to rotate. Controlling variation of the electrical signals controls the stator rotating magnetic field, and accordingly, controls rotation of the rotor.

In some examples, FOC control of an alternating current (AC) motor is sensorless. In some examples, sensorless motor control avoids the use of separate speed and position sensors that are mechanically attached to a motor. Sensors directly attached to a motor can detrimentally affect the performance of the motor, such as by reducing a maximum torque output per volume and drive system reliability. Sensorless motor control may be performed by mathematically deriving one or more characteristics of a motor, such as motor speed and rotor position, based on feedback from the motor itself. Additional disclosure relating to FOC control of a motor system can be found in U.S. Pat. No. 10,666,180, which is incorporated herein by reference.

### SUMMARY

In described examples, a device includes a non-transitory memory and a processor. The memory stores a first instruction. The processor receives the first instruction from the memory. Executing the first instruction causes the processor to perform the following actions. The processor receives a position vector corresponding to a sum of a first component in a first dimension and a second component in a second dimension. The processor compares a magnitude of the first component to a magnitude of the second component, and compares the first component or the second component to zero. And the processor determines a sector in which the position vector is located responsive to the compare actions and a sector layout. In some examples, execution of additional instructions causes the processor to operate a rotational system in response to the determined sector.

### BRIEF DESCRIPTION OF THE DRAWINGS

FIG. 1 is a controlled system in which an integrated circuit (IC) controls a rotational system.

FIG. 2 is a functional block diagram of an example permanent magnet motor system with the FOC control circuit and the rotational system.

FIG. 3 is a graph illustrating an example sector layout within a rotor position vector space, with an example position vector for the permanent magnet motor and example control vector signals for the PWM controller of FIG. 2.

FIG. 4 is a graph illustrating an alternative example sector layout within the rotor position vector space of the graph of FIG. 3.

FIG. 5 is a graph illustrating a process for determining which sector a position vector is located in.

FIG. 6A is a first graph of an example position vector within the sector layout of FIG. 3.

FIG. 6B is a second graph of the example position vector, rescaled to form a rescaled position vector within the sector layout of FIG. 4.

FIG. 7 is an example control system for the three phase inverter of FIG. 2.

FIG. 8 is a process for determining an arctangent of a position vector.

FIG. 9 is a process for determining a sector corresponding to a position vector.

### DETAILED DESCRIPTION

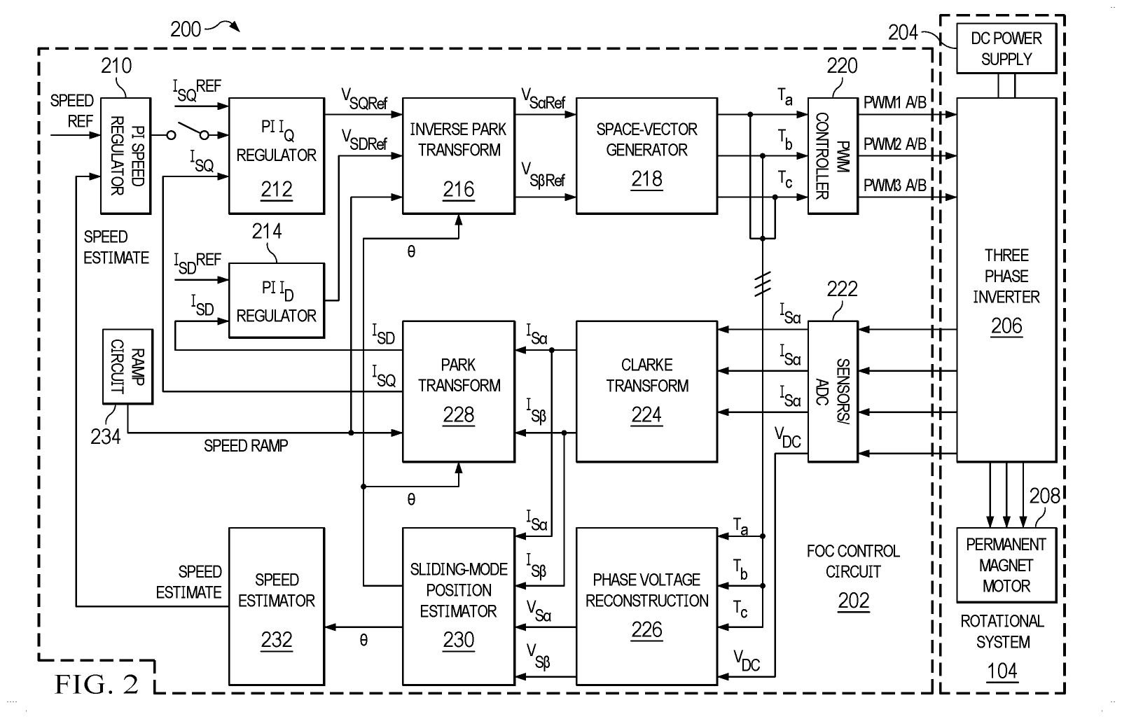

In some examples, as detailed later (for instance, with respect to the permanent magnet motor system 200 of FIG. 2), an FOC control circuit 202 controlling a permanent magnet motor 208 uses measurements of a back-electromagnetic force (BEMF) waveform induced by the permanent magnet motor 208 to generate feedback signals as part of the control function. BEMF is generated by field interaction between rotor magnets and stator windings of the permanent magnet motor 208. In some examples, the feedback signals generated using BEMF waveform measurements include a rotor position estimate and a rotor speed estimate. In some examples, these estimates are determined with respect to a reference position of the rotor. References herein to position are with respect to the reference position.

In some examples, the rotor position estimate and the rotor speed estimate are used to generate orthogonal components, such as x and y components, of a two-dimensional voltage vector. This voltage vector corresponds to a position vector of the rotor. In some examples, a coordinate space within which the position of the rotor is represented is divided into a number of sectors. A sector number that identifies a sector may also be referred to as an index. The sector (or index) number refers to a location or location range within a vector space, such as an angular space within a circular track of travel of a motor. The x and y components of the position vector can be used to determine which sector the rotor is located in.

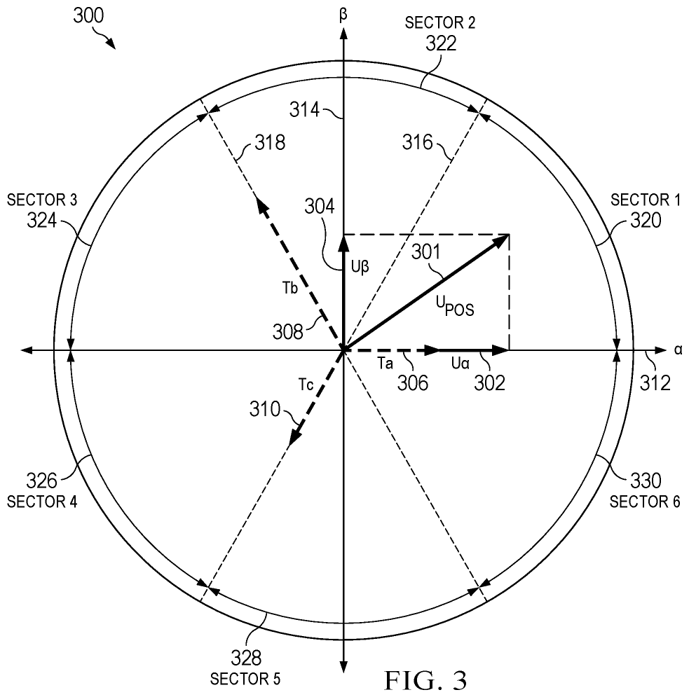

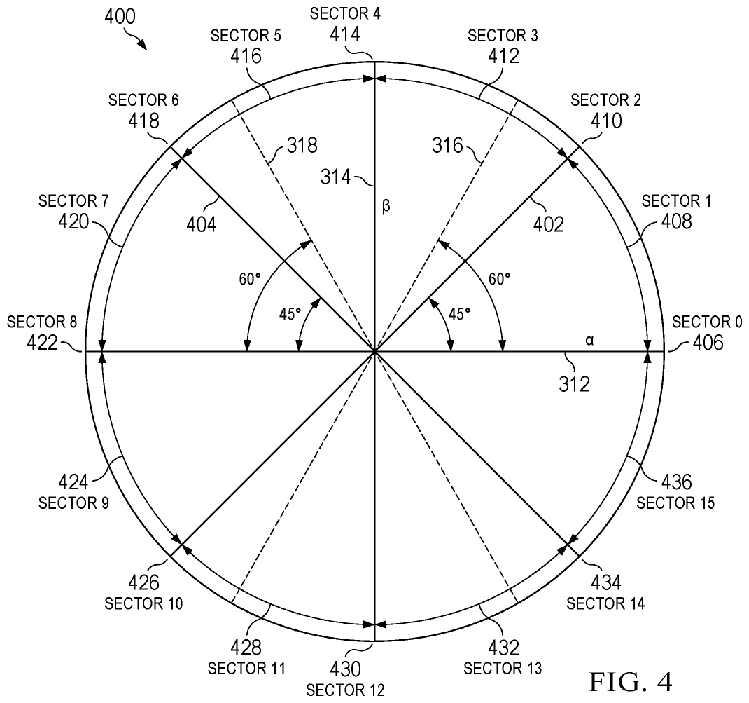

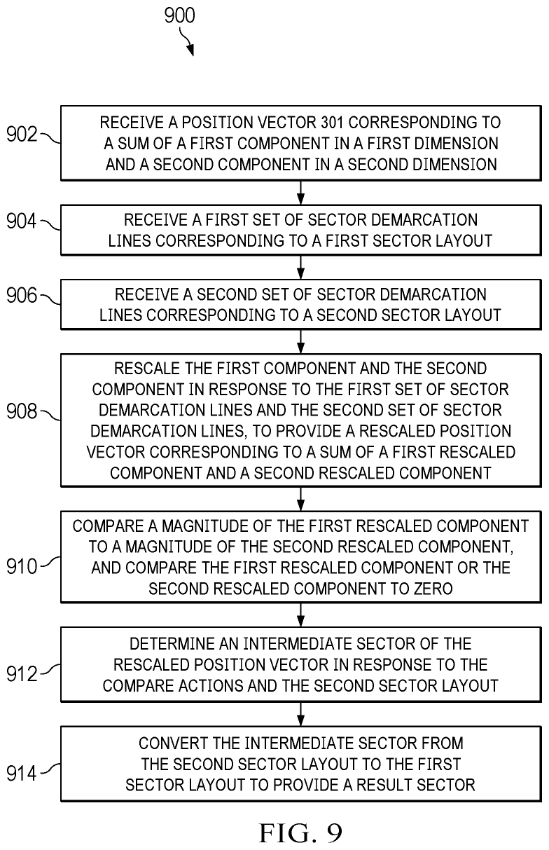

Sector determination is further described with respect to FIGS. 3 through 6B and 8. In some examples, IC hardware, as well as systems under control thereof, may be improved (e.g., accelerated), for example in combination with an assembly (or other) language instruction used to accelerate sector determination. Such hardware and/or instruction can also be used to accelerate determination of a full circle, per-unit arctangent, as further described with respect to FIGS. 4 and 9. In some examples, per-unit arctangent determinations are used in a control loop of a rotational system such as the permanent magnet motor system 200.

FOC sets a current vector to control the motor so that a rotating flux is generated in the motor to apply a desired torque to efficiently control the rotor to spin at a speed corresponding to the rotor speed input. The x and y components of the position vector, with the determined sector, can be used to determine the current vector to efficiently control the motor.

In some examples, a rescaling of the position vector can be used to enable one or more performance improvements, including rapid, low power, low processing cost determination of the sector in which the rotor is located. This enables rapid, efficient updating of the control vector. In some examples, this improves efficiency and/or accuracy of rotor control.

In some examples, similar systems and processes described herein with respect to permanent magnet motors are also applicable to induction motors and other rotational systems.

Herein, current signals are named I-subscript-[name], and voltage signals are named V-subscript-[name]. For signals in the DQ coordinate system, D axis signals include D in their name, and Q axis signals include Q in their name. Similarly, for signals in the αβγ (alpha-beta-gamma) coordinate system, a axis signals include α in their name, and β axis signals include β in their name. Also, the same reference numbers or other reference designators are used in the drawings to designate features that are related structurally and/or functionally.

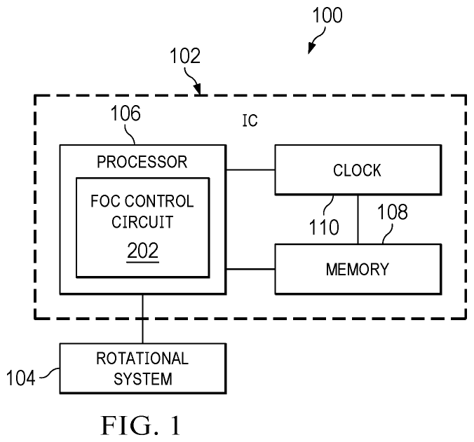

FIG. 1 is a controlled system 100 in which an IC 102 controls a rotational system 104. The IC 102 includes a processor 106, a memory 108, and a clock generator 110 that are fabricated on the IC 102. The processor 106 includes an FOC control circuit 202. The processor 106 is communicatively connected to the memory 108. The processor 106 and the memory 108 are connected to be clocked by the clock generator 110. The processor 106 is connected to control the rotational system 104, and to receive feedback, such as BEMF signals, from the rotational system 104.

FIG. 2 is a functional block diagram of an example permanent magnet motor system 200 with the FOC control circuit 202 and the rotational system 104. Although this disclosure describes the system 200 as including a permanent magnet motor, certain techniques of this disclosure can be implemented with other types of motors, such as induction motors or synchronous motors, or other types of rotational systems, such as direct current to alternating current (DC-to-AC) converters. In some examples, DC-to-AC converters are used in solar inverters. The rotational system 104 includes a DC power supply 204, a three phase inverter 206, and the permanent magnet motor 208.

The FOC control circuit 202 includes a proportional integral (PI) speed regulator 210, a PI I_{Q} regulator 212, a PI I_{D} regulator 214, an inverse Park transform circuit 216, a space-vector generator 218, a pulse width modulation (PWM) controller 220, a sensors/analog-to-digital (ADC) circuit 222, a Clarke transform circuit 224, a phase voltage reconstruction circuit 226, a Park transform circuit 228, a sliding-mode position estimator 230, a speed estimator 232, and a ramp circuit 234. In some examples, the FOC control circuit 202 can be used to control a permanent magnet motor in a vehicle (such as an electric vehicle, electric scooter or bicycle), HVAC (heating, ventilation, and air conditioning) system, pump, actuator, compressor, or robot.

In some examples, performance of the permanent magnet motor 208, controlled using FOC, is reduced at low rotor speeds due to a low signal-to-noise (SNR) ratio of the BEMF signals generated by the permanent magnet motor 208. Low-SNR BEMF signals reduce the accuracy of angular speed and position estimates that depend on BEMF waveform measurements. Accordingly, in some examples, at low rotor speeds, the permanent magnet motor 208 is controlled using an open loop (no feedback) functionality of the FOC control circuit 202. Open loop control relies on a command rotor position and an external rotor speed input to determine current vectors applied to control the permanent magnet motor 208. A command rotor position is an angle at which force is applied by the stator to the rotor and can be referred to as a force angle.

The FOC control circuit 202 switches over to closed loop (feedback-dependent) operation once the rotor reaches a speed threshold. In closed loop mode, the FOC control circuit 202 uses the rotor speed input, as well as estimated rotor position (e.g., an estimated angle position) and estimated speed feedback signals, to determine current vectors applied to control the permanent magnet motor 208. An estimated rotor position is an angle of the rotor determined using a sliding-mode observer. The sliding-mode observer operates using sliding-mode control concepts. Sliding mode control is a nonlinear control method that uses set-valued control signals to cause a system to “slide” along a cross-section of the normal behavior of the system. In some examples, another type of observer, such as a Luenberger observer, is used to determine estimated rotor position and estimated speed.

The PI speed regulator 210 receives, at a first input, a speed reference signal (Speed Ref) used to set a speed of the permanent magnet motor 208. A second input of the PI speed regulator 210 is connected to an output of the speed estimator 232 to receive a speed estimate signal (Speed Estimate) as a feedback value. The Speed Estimate signal represents feedback identifying an estimate of the actual speed of the permanent magnet motor 208. A first input of the PI I_{Q} regulator 212 is switchably connected to receive an I_{SQ} reference (I_{SQ} Ref) at a first input if the permanent magnet motor system 200 is in an open loop mode (also referred to herein as open loop operation). Open loop mode is used during, for example, startup of the permanent magnet motor 208 and, as introduced above, during relatively low speed operations. The first input of the PI I_{Q} regulator 212 is switchably connected to an output of the PI speed regulator 210 while the permanent magnet motor system 200 is in a closed loop mode (also referred to herein as closed loop operation). Closed loop mode is used after the permanent magnet motor 208 is spinning at a rate sufficient to enable accurate use of estimated speed and estimated position (rotor angle, or θ (theta)) to control three phase power provided to the permanent magnet motor 208. A second input of the PI I_{Q} regulator 212 is connected to a first output of the Park transform circuit 228 to receive I_{SQ}.

A first input of the PI I_{D} regulator 214 receives an I_{SD} reference (I_{SD}) Ref). A second input of the PI I_{D} regulator 214 is connected to a second output of the Park transform circuit 228 to receive I_{SD}.

A first input of the inverse Park transform circuit 216 is connected to an output of the PI I_{Q} regulator 212 to receive V_{SQRef}. A second input of the inverse Park transform circuit 216 is connected to an output of the PI I_{D} regulator 214 to receive V_{SDRef}. A third input of the inverse Park transform circuit 216 is connected to an output of the ramp circuit 234 to receive a Speed Ramp signal, which is used during open loop operation. A fourth input of the inverse Park transform circuit 216 is connected to an output of the sliding-mode position estimator 230 to receive a θ signal, which is used during closed loop operation.

A first input of the space-vector generator 218 is connected to a first output of the inverse Park transform circuit 216 to receive V_{SαRef}. A second input of the space-vector generator 218 is connected to a second output of the inverse Park transform circuit 216 to receive V_{SβRef}. V_{SαRef} corresponds to an α dimension component of the position of the rotor referred to herein as Ualpha or Uα, accordingly, a Uα vector that can be described as located on the α axis. V_{SβRef} corresponds to a β dimension component of the position of the rotor referred to herein as Ubeta or Uβ, accordingly, a Uβ vector that can be described as located on the β axis.

First, second, and third inputs of the PWM controller 220 are respectively connected to first, second, and third outputs of the space-vector generator 218 to respectively receive Tₐ, T_{b}, and T_{c} voltage vector signals. Tₐ, T_{b}, and T_{c} are used to determine duty cycles of signals generated by the PWM controller 220. Uα and Uβ are used to determine Tₐ, T_{b}, and T_{c}, as further described with respect to FIG. 3 and following.

Power and ground inputs of the three phase inverter 206 are respectively connected to power and ground outputs of the DC power supply 204. First, second, and third control inputs of the three phase inverter 206 are connected to first, second, and third outputs of the PWM controller 220 to receive PWM control signals PWM1 A/B, PWM2 A/B, and PWM3 A/B. In some examples, the control inputs of the PWM controller 220 are each pairs of inputs (for A and B signals), and the outputs of the PWM controller 220 are similarly pairs of outputs. The three phase inverter 206 converts DC power received from the DC power supply 204 to three phase AC power in response to the PWM control signals received from the PWM controller 220. First phase, second phase, and third phase control inputs of the permanent magnet motor 208 are respectively connected to first phase, second phase, and third phase outputs of the three phase inverter 206.

In some examples, the permanent magnet motor 208 includes a rotor with permanent magnets embedded in or connected to the rotor. The permanent magnet motor 208 also includes a stator, for example with multiple teeth, around which conductive windings are wound. The windings are selectively energized and de-energized, based on the signals from the three phase inverter 206, to create a rotating magnetic field to which the rotor magnets respond, causing the rotor to rotate. As further described below, the permanent magnet motor 208 generates a BEMF waveform. The sensors/ADC circuit 222 measures this BEMF waveform as part of generating feedback signals used to control the permanent magnet motor system 200.

First, second, and third inputs of the Clarke transform circuit 224 are connected to first, second, and third outputs of the sensors/ADC circuit 222 to receive I_{Sa}, I_{Sb}, and I_{Sc}. First, second, and third inputs of the phase voltage reconstruction circuit 226 are connected to first, second, and third outputs of the space-vector generator 218 to receive Tₐ, T_{b}, and T_{c} voltage vector signals. A fourth input of the phase voltage reconstruction circuit 226 is connected to a fourth output of the sensors/ADC circuit 222 to receive V_{DC}. V_{DC} is the DC bus voltage, that is, the voltage of the DC power supply 204.

First and second inputs of the sliding-mode position estimator 230 are connected to first and second outputs of the phase voltage reconstruction circuit 226 to receive V_{Sα} and V_{Sβ}. Third and fourth inputs of the sliding-mode position estimator 230 are connected to first and second outputs of the Clarke transform circuit 224 to receive I_{Sα} and I_{Sβ}. First and second inputs of the Park transform circuit 228 are connected to first and second outputs of the Clarke transform circuit 224 to receive I_{Sα} and I_{Sβ}. A third input of the Park transform circuit 228 is connected to an output of the ramp circuit 234 to receive the Speed Ramp signal. A fourth input of the Park transform circuit 228 is connected to an output of the sliding-mode position estimator 230 to receive the 0 signal. An input of the speed estimator 232 is connected to an output of the sliding-mode position estimator 230 to receive the θ signal.

The permanent magnet motor 208 is controlled by generating I_{D} and I_{Q} current commands for the D and Q axes, respectively. The I_{D} current command is used to control the magnetizing flux of the motor, while the I_{Q} current command is used to control the motor torque. These current commands are then converted to V_{D} and V_{Q} voltage commands for the D and Q axes, respectively. The V_{D} and V_{Q} voltage commands define a voltage vector that is used to generate three phase voltages for the permanent magnet motor 208.

The PI speed regulator 210 includes a combiner and a speed controller. As described above, the PI speed regulator 210 receives a commanded speed as the Speed Ref signal, as well as the Speed Estimate signal. As noted earlier, the Speed Estimate signal feeds back an estimate of the actual speed of the permanent magnet motor 208. The PI speed regulator 210 generates a difference between the Speed Ref and Speed Estimate signals, which is a speed error signal. The PI speed regulator 210 uses the speed error signal to generate a corrective current command for the motor, so as to reduce the speed error signal.

The PI I_{Q} regulator 212 includes a combiner and a regulator. I_{SQ} is a feedback signal that represents a measurement of the actual current in the Q axis. The PI I_{Q} regulator 212 generates a difference between either the current command provided by the PI speed regulator 210 or I_{SQ} Ref (depending on whether the permanent magnet motor system 200 is in open loop mode or closed loop mode), and I_{SQ}, as an error signal. The PI I_{Q} regulator 212 uses this error signal to generate the voltage command V_{SQRef} for the motor.

The PI I_{D} regulator 214 includes a combiner and a regulator. I_{SD} is a feedback signal that represents a measurement of the actual current in the D axis. The PI I_{D} regulator 214 generates a difference between I_{SD} Ref and Is as an error signal. The PI I_{D} regulator 214 uses this error signal to generate the voltage command V_{SDRef} for the motor.

The inverse Park transform circuit 216 uses the V_{SQRef}, V_{SDRef}, and θ signals or the Speed Ramp signal (depending on operation mode) to convert the time-invariant V_{SQRef} and V_{SDRef} signals into the time-dependent V_{SαRef} and V_{SβRef} signals. The space-vector generator 218 uses the V_{SαRef} and V_{SβRef} signals, which represent a two-phase voltage vector, to generate three phase voltage signals Tₐ, T_{b}, and T_{c}. These three phase voltage signals define the voltages to be applied to the “A,” “B,” and “C” windings of the stator during the three phases of the permanent magnet motor 208. The PWM controller 220 converts the three phase voltage signals Tₐ, T_{b}, and T_{c} into PWM signals PWM1 A/B, PWM2 A/B, and PWM3 A/B for driving transistor switches in the three phase inverter 206.

The FOC control circuit 202 uses sensorless FOC to control the permanent magnet motor 208. That is, the FOC control circuit 202 does not receive sensor measurements from sensors mounted in or on the permanent magnet motor 208. Rather, the FOC control circuit 202 uses the BEMF waveform to infer one or more characteristics of the permanent magnet motor 208, such as rotor speed or rotor position. The BEMF waveform sensed by the sensors/ADC circuit 222 is dependent on the position and speed of the rotor. The BEMF waveform is caused by periodic changes of magnetic fluxes on the rotor. Magnetic fluxes are induced on the rotor by the movement of the rotor magnets with respect to the stator charged windings. The sensors/ADC circuit 222 uses both voltage and current information to obtain the BEMF waveform.

The permanent magnet motor 208 is a three phase time-dependent and speed-dependent system. Accordingly, the signals provided by the sensors/ADC circuit 222 corresponding to measured BEMF represent data in a three phase time-dependent and speed-dependent coordinate system. This coordinate system can be transformed via projection into a two-coordinate time-invariant synchronous system.

The Clarke transform circuit 224 transforms the time-dependent three phase (three dimensional) signals I_{Sa}, I_{Sb}, and I_{Sc} into time-dependent two phase (two dimensional) signals I_{Sα} and I_{Sβ}. The Park transform circuit 228 transforms the time-dependent two phase signals I_{Sα} and I_{Sβ} into time-invariant two phase signals using either the θ signal or the Speed Ramp signal (depending on the operating mode of the permanent magnet motor system 200). The two coordinate axes of outputs, I_{SQ} and I_{SD}, of the Park transform circuit 228 and downstream signals (up to the inverse Park transform circuit 216) are referred to as the D and Q axes. The phase voltage reconstruction circuit 226 uses PWM duty cycle information provided by Tₐ, T_{b}, and T_{c}, as well as DC voltage information measured by the sensors/ADC circuit 222, to determine output phase voltages. Output phase voltage is the voltage between a line from the three phase inverter 206 to the permanent magnet motor 208, and neutral. Output phase voltage is provided by the phase voltage reconstruction circuit 226 as two phase voltage information (V_{Sα} and V_{Sβ}).

The sliding-mode position estimator 230 and the speed estimator 232 use a cascaded observer-based estimation algorithm to respectively identify position and velocity estimates for the permanent magnet motor 208, including in noisy environments. The sliding-mode position estimator 230 uses two phase voltage information (V_{Sα} and V_{Sβ}) received from the phase voltage reconstruction circuit 226, and two phase current information (I_{Sα} and I_{Sβ}) received from the Clarke transform circuit 224, to determine an estimated rotor angular position 0. The speed estimator 232 uses the resulting θ signal to estimate the rate of change in the angular position of the rotor.

FIG. 3 is a first graph illustrating an example sector layout 300 within a rotor position vector space, with an example position vector 301 for the permanent magnet motor 208 and example control vector signals for the PWM controller 220 of FIG. 2. The position vector (U_{POS}) 301 is represented by orthogonal components Uα 302 and Uβ 304, and the control vector signals correspond to the three phase voltage signals Tₐ 306, T_{b} 308, and T_{c} 310. The Uα 302 vector is aligned with an α axis 312, and the Uβ 304 vector is aligned with a B axis 314. The Tₐ 306, Th 308, and T_{c} 310 vectors are determined in response to the Uα 302 vector and the Uβ 304 vector.

The α axis 312 and the β axis 314 together describe a vector space within which an estimated position of the rotor and vectors representing the control vector signals may be represented. A first line 316, also referred to herein as a 60° (60 degree) line 316, indicates 60° and 240° from the α axis 312. A second line 318, also referred to herein as a 120° line 318, indicates 120° and 300° from the α axis 312.

Together, the α axis 312, the 60° line 316, and the 120° line 318 can be used to define six sectors within which the position vector 301 of the rotor, represented by the Uα and Uβ component vectors 302 and 304, may be located. These are a first sector 320 (sector 1), a second sector (sector 2) 322, a third sector (sector 3) 324, a fourth sector (sector 4) 326, a fifth sector (sector 5) 328, and a sixth sector (sector 6) 330. The first sector 320 is located from 0° to 60°, the second sector 322 is located from 60° to 120°, the third sector 324 is located from 120° to 180°, the fourth sector 326 is located from 180° to 240°, the fifth sector 328 is located from 240° to 300°, and the sixth sector 330 is located from 300° to 0° (360°).

In some examples, the processor 106 determines which of the six sectors 320, 322, 324, 326, 328, or 330 the position vector 301 is located in to enable determination of values of Tₐ 306, T_{b} 308, and T_{c} 310 for efficient control of the permanent magnet motor 208 by the three phase inverter 206. In some examples, use of six sectors facilitates the above-described efficient control of a rotational system 104 operated using AC current with a three phase voltage waveform. In some examples, a different number of sectors facilitates efficient operation of a rotational system 104 operated using a different type of waveform, such as a waveform with a different number of phases.

FIG. 4 is a graph illustrating an alternative example sector layout 400 within the rotor position vector space of the sector layout 300 of FIG. 3. The sector layout 400 includes sixteen sectors, which are described by the α axis 312, the β axis 314, a third line 402 that is 45° (and) 225° from the α axis 312, and a fourth line 404 that is 135° (and) 315° from the α axis 312. The third line 402 is also referred to as the 45° line 402, and the fourth line 404 is also referred to as the 135° line 404. Some of the sixteen sectors correspond to regions that span an angular range of the vector space, and some of the sixteen sectors correspond to locations on the α axis 312, the β axis 314, the 45° line 402, or the 135° line 404.

Accordingly, the sector layout 400 includes a first sector (sector 0) 406 at 0°, a second sector (sector 1) 408 between 0° and 45°, a third sector (sector 2) 410 at 45°, a fourth sector (sector 3) 412 between 45° and 90°, a fifth sector (sector 4) 414 at 90°, a sixth sector (sector 5) 416 between 90° and 135°, a seventh sector (sector 6) 418 at 135°, an eighth sector (sector 7) 420 between 135° and 180°, a ninth sector (sector 8) 422 at 180°, a tenth sector (sector 9) 424 between 180° and 225°, an eleventh sector (sector 10) 426 at 225°, a twelfth sector (sector 11) 428 between 225° and 270°, a thirteenth sector (sector 12) 430 at 270°, a fourteenth sector (sector 13) 432 between 270° and 315°, a fifteenth sector (sector 14) 434 at 315°, and a sixteenth sector (sector 15) 436 between 315° and 360°.

In an example, the processor 106 and/or the FOC control circuit 202 (for example, the space vector generator 218) may determine the sector in the sector layout 400 within which the position vector 301 (see FIG. 3; not shown in FIG. 4) is located using three comparisons: between a magnitude of Uα 302 and a magnitude of Uβ 304, between Uα 302 and zero, and between Uβ 304 and zero. These relationships are shown in Table 1, below.

TABLE 1

| | | | |
|---|---|---|---|
| Sector 0 | \|Uα\| > \|Uβ\| | Uα > 0 | Uβ = 0 |
| Sector 1 | \|Uα\| > \|Uβ\| | Uα > 0 | Uβ > 0 |
| Sector 2 | \|Uα\| = \|Uβ\| | Uα > 0 | Uβ > 0 |
| Sector 3 | \|Uα\| < \|Uβ\| | Uα > 0 | Uβ > 0 |
| Sector 4 | \|Uα\| < \|Uβ\| | Uα = 0 | Uβ > 0 |
| Sector 5 | \|Uα\| < \|Uβ\| | Uα < 0 | Uβ > 0 |
| Sector 6 | \|Uα\| = \|Uβ\| | Uα < 0 | Uβ > 0 |
| Sector 7 | \|Uα\| > \|Uβ\| | Uα < 0 | Uβ > 0 |
| Sector 8 | \|Uα\| > \|Uβ\| | Uα < 0 | Uβ = 0 |
| Sector 9 | \|Uα\| > \|Uβ\| | Uα < 0 | Uβ < 0 |
| Sector 10 | \|Uα\| = \|Uβ\| | Uα < 0 | Uβ < 0 |
| Sector 11 | \|Uα\| < \|Uβ\| | Uα < 0 | Uβ < 0 |
| Sector 12 | \|Uα\| < \|Uβ\| | Uα = 0 | Uβ < 0 |
| Sector 13 | \|Uα\| < \|Uβ\| | Uα > 0 | Uβ < 0 |
| Sector 14 | \|Uα\| = \|Uβ\| | Uα > 0 | Uβ < 0 |
| Sector 15 | \|Uα\| > \|Uβ\| | Uα > 0 | Uβ < 0 |

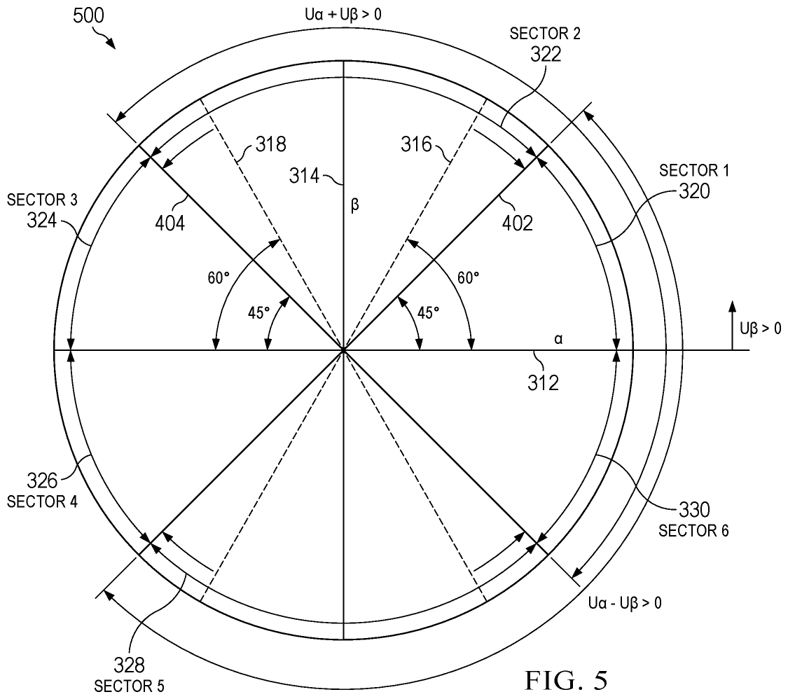

In some examples, other comparisons than those shown in Table 1 can be used for sector determination, such as sign (Uα), sign (Uβ), Uα==0 (does Uα equal zero), and Uβ==0. Additional examples are provided below, such as with respect to FIG. 5.

In some examples, sectors 0, 2, 4, 6, 8, 10, 12, and 14 (406, 410, 414, 418, 422, 426, and 430), which are located at boundary lines, are included to correspond to available results for comparisons such as those described in Table 1. These sectors may correspond to an estimated position vector of a rotational system such as the rotational system 104. Note that in some examples, position is not estimated with infinite precision, and a position estimate may fall on a boundary line.

By way of introduction, an instruction QUADF, in an example implementation, accepts two operands Mx and My. Mx is an x coordinate (or a coordinate in the α-β coordinate system) and My is a y coordinate (or β coordinate in α-β coordinate system). QUADF returns four operands TDM, Mx, My, and Mz. TDM is a sector number from 0 to 15 (for example, sector 0 406 to sector 15 436). The returned Mx and My correspond to the accepted Mx and My operands, which may be conditionally switched when returned, and Mx may be conditionally inverted (multiplied by negative one) when returned (in the example, prior to the conditional switch). As described above, Mz is a scalar value used to adjust an arctangent result from a limited range (such as −45° to) 45° to a full circle range (such as −180° to 180°). QUADF is further described below.

In some examples, the sector determination can be made in response to the instruction QUADF. In some examples, a quadrant value (Mz) corresponding to the sector in which the position vector 301 is located can also be determined using QUADF. The name QUADF refers to a floating point quadrant determination instruction. The quadrant value is used to adjust a narrow-range arctangent result to a correct angular position within a full circle range. In some examples, QUADF is an assembly language instruction. In other examples, QUADF may be a higher level language instruction. In some examples, QUADF can be processed by the processor 106 within a single cycle of the clock generator 110. In some examples, clock frequencies range from 100 megahertz to 2 gigahertz (or more).

In some examples, the QUADF function can be called using four operands, further defined below, such as QUADF TDM Mx My Mz. Such examples include using QUADF as part of a process for determining control vectors Tₐ 306, T_{b} 308, and T_{c} 310 (or other control vectors for a permanent magnet motor 208 or other motor or other rotational system 104), or as part of a process for determining atan 2pu( ) in a 32-bit instruction context. Example meanings and usages of the TDM, Mx, My, and Mz operands are further described below. The atan 2pu( ) instruction is described below in the context of atan( ) atan 2( ) and puatan( ) instructions; in some architectures, these instructions are implemented and/or used as described.

In some examples, such as examples in which QUADF is used as part of a process for determining atan 2pu( ) in a 64-bit instruction context, QUADF can be called using five operands, such as QUADF TDM Mw Mx My Mz. In this example, Mw is an address for a register for storing the atan 2pu( ) result (an angle value) in a 64-bit floating point format. In some examples, QUADF uses a different arrangement of operands than those described above. In some examples, use of the QUADF instruction to facilitate determination of an arctangent enables faster, more efficient, and/or higher precision results.

In some examples, the operands of the QUADF instruction are register or other memory addresses or other identifiers. As described above, in some examples, these addresses or identifiers include TDM, Mx, My, and Mz. TDM corresponds to four one-bit flags that together store a four bit value indicating a sector within the sector layout 400, ranging from 0000 (sector 0) to 1111 (sector 15). Accordingly, the TDM flags together represent a binary number corresponding to the base ten sector number within the sector layout 400. Mx is an address of a register that stores an x coordinate (also referred to as Mx), such as Uα 302. My is an address of a register that stores a y coordinate (also referred to as My), such as Uβ 304. Mz is an address of a register for storing the quadrant value corresponding to the sector in which the position vector 301 is located (also referred to as Mz). In some examples, QUADF reads Mx and My, and writes to the TDM flags and to the registers indicated by Mx, My, and Mz.

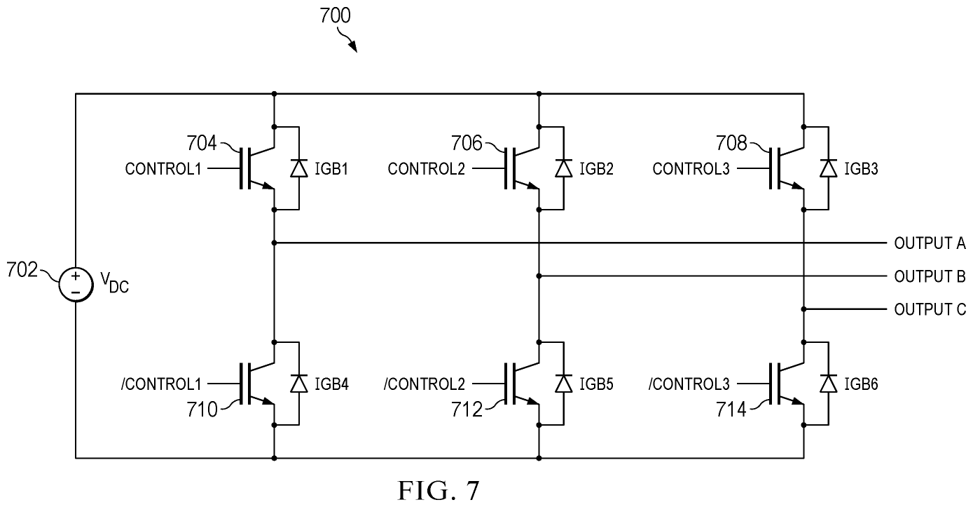

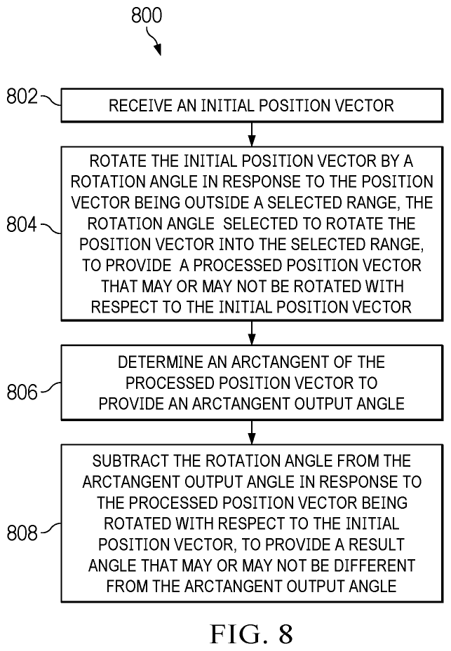

Use of QUADF and Mz to determine an accurate, full circle, per-unit arctangent result is described below. Per-unit refers to an arctangent result normalized to a range of negative one to one (for example, from a range of negative x to). Use of QUADF and TDM to determine a sector corresponding to a position vector 301 for a sector layout other than the sector layout 400 is described with respect to FIGS. 5, 6A, 6B, and 7. Use of a determined sector to control a rotational system 104 is described with respect to FIGS. 7 and 8. In some examples, the QUADF instruction is implemented in circuits of the processor 404 so that the QUADF instruction can be executed by the processor 404 within one cycle of the clock 408. The memory 406 may store the QUADF instruction for execution by the processor 404.

In some examples, a value written by the QUADF instruction to the register indicated by Mz can be used to determine a result for a two operand instruction for determining a per-unit arctangent of a position vector 301 located at any position within a full circle, accordingly, atan 2pu( ). The instruction atan(r) determines an arctangent of a single operand r (a ratio), has a range of −π/2 (−90°) to π/2 (90°), and in some examples, is accurate between negative π/4 (−45°) and π/4 (45°). The instruction puatan(r) returns an atan(r) result normalized to provide values from −½ to ½, instead of from −π/2 to π/2. In some examples, puatan(r) is accurate between negative π/4 (−45°) and π/4 (45°). The instruction atan 2(y, x) determines an arctangent of a ratio y/x between two operands (i.e., y and x), and has range −π (−180°) to π (180°). The instruction atan 2pu(y, x) returns an atan 2(y, x) result normalized to provide values from −1 to 1, instead of from −π to π.

In some examples, puatan( ) is a relatively fast instruction for the processor 106 to process, for example, compared to atan 2pu( ) Accordingly, in some examples, faster processing of atan 2pu( ) is enabled by using QUADF and puatan( ) In some examples, QUADF is used because puatan( ) is most accurate between −45° and 45°, and because puatan( ) does not distinguish between inputs corresponding to (1) negative y and positive x (270° to 0°, sectors 12 to 16), and positive y and negative x (90° to 180°, sectors 4 to 8); or (2) positive y and positive x (0° to 90°, sectors 0 to 4), and negative y and negative x (180° to 270°, sectors 8 to 12). These distinctions are enabled by an offset provided by Mz, and by certain modifications to Mx and My that QUADF makes in corresponding sectors. Table 2 relates sector number within the sector layout 400 to QUADF modifications to Mx and My, and to value of Mz.

TABLE 2

| Sector Number | Mx and My change | Mz value |
|---|---|---|
| Sector 0 | None | 0.0 |
| Sector 1 | None | 0.0 |
| Sector 2 | None | 0.0 |
| Sector 3 | Negate Mx, then swap Mx and My | 0.25 |
| Sector 4 | Swap Mx and My | 0.25 |
| Sector 5 | Negate Mx, then swap Mx and My | 0.25 |
| Sector 6 | None | 0.5 |
| Sector 7 | None | 0.5 |
| Sector 8 | None | 0.5 |
| Sector 9 | None | −0.5 |
| Sector 10 | None | −0.5 |
| Sector 11 | Negate Mx, then swap Mx and My | −0.25 |
| Sector 12 | Swap Mx and My | −0.25 |
| Sector 13 | Negate Mx, then swap Mx and My | −0.25 |
| Sector 14 | None | 0.0 |
| Sector 15 | None | 0.0 |

Sectors 3, 4, and 5 are between (and do not include) 45° and 135°. Sectors 11, 12, and 13 are between (and do not include)) 225° (−135°) and 315° (−45°). The changes that are made to Mx and My (corresponding to the Uα and Uβ vectors 302 and 304) in sectors 3, 4, 5, 11, 12, and 13 rotate the corresponding position vector 301 about the origin by −90°, relocating the position vector 301 so that the ratio that puatan( ) processes corresponds to the range −45° to 45°. Recall that puatan( ) is most accurate between −45° and 45°, and that puatan( ) does not distinguish between certain sectors. For example, puatan( ) does not distinguish between the range 0° to 45° and the range 180° to 225° (both correspond to a positive ratio); or between the range 0° to −45° (315°) and the range 135° to 180° (both correspond to a negative ratio). The value of Mz (1) adjusts the result of puatan( ) to compensate for the sector indifference of puatan( ) and (2) for sectors 3, 4, 5, 11, 12, and 13, rotates the result back to the sector containing the position vector 301.

In an example, Mx is negative and My is negative, corresponding to sector 9. Mz equals −0.5 in sector 9. The puatan( ) instruction receives the Mx and My inputs as a ratio in sector 1 (−y/−x=y/x). The −0.5 value of Mz rotates the puatan( ) result by −180°, so that the atan 2pu( ) result is located in sector 9, corresponding to the original Mx and My inputs.

In another example, Mx is negative and My is positive, corresponding to sector 5. Mz equals 0.25 in sector 5. QUADF negates Mx (Mx is set to negative Mx) and swaps My and Mx (see Table 2). Accordingly, QUADF rotates the position vector 301 −90° into sector 1. The 0.25 value of Mz rotates the puatan( ) result by 90°, so that the atan 2pu( ) result is located in sector 5, corresponding to the original Mx and My inputs. In some examples, the QUADF instruction enables an atan 2pu( ) instruction to be processed within 14 cycles of the clock generator 110.

In some examples, QUADF can be used with PUATANF and/or CORDICATANF (or other instructions) to determine a result for an atan 2pu( ) instruction. In some examples, a coordinate rotation digital computer (CORDIC) instruction or process uses a binary search to determine a result. CORDIC refers to an iterative method for solving certain types of mathematical problems. PUATANF refers to a floating point instruction for determining a per-unit arctangent.

FIG. 5 is a graph 500 illustrating a process for determining which sector a position vector 301 (not shown in FIG. 5) is located in. In an example in which the sectors are divided other than at 45° intervals (such as in the sector layout 300), a sector corresponding to the position vector 301 can be determined by rescaling the position vector 301. In the sector layout 300 of FIG. 3, the 60° line 316 and the 120° line 318, demarcating 60° intervals starting at the α axis 312, are used to divide and indicate sectors. In the sector layout 400 of FIG. 4, the 45° line 402 and the 135° line 404, demarcating 45° intervals starting at the α axis 312, are used to divide and indicate sectors. The example illustrated by the graph 500 of FIG. 5 shows the sector layout 300 of FIG. 3, rescaled to correspond to the sector layout 400 of FIG. 4; accordingly, so that the 45° line 402 and the 135° line 404 are used to divide and indicate sectors. This rescaling establishes a correspondence between the sector layout 300 and the sector layout 400.

The Uα vector 302 and the Uβ vector 304 can be rescaled so that the lines demarcating transitions between sectors are transformed to the 45° line 402 and the 135° line 404. This enables a sector location within sectors that are demarcated by a selectable set of lines to be determined using a process for determining sectors demarcated by the 45° line 402 and the 135° line 404, such as using the QUADF instruction, or otherwise as shown in or described with respect to Table 1. In some examples, the Uα vector 302 corresponds to the Mx operand of QUADF and the Uβ vector 304 corresponds to the My operand of QUADF.

In an example, the Uα vector 302 can be rescaled as shown in Equation 1 and the Uβ vector 304 can be rescaled as shown in Equation 2:

$$Mx = U α / \vert sin ( demarccating line angle ) \vert \qquad Equation 1$$

$$My = U β / \vert cos ( demarcating line angle ) \vert \qquad Equation 2$$

Demarcating line angle refers to the angle from the a (or x) axis 312 to a line (or lines) demarcating sectors, such as the 60° line 316 and the 120° line 318. The demarcating line angle for the 60° line 316 is 60°, and the demarcating line angle for the 120° line 318 is 120°. Accordingly, for this example, Mx=Uα×\sqrt{3}/2 (approximately 0.866) and My=Uβ×0.5.

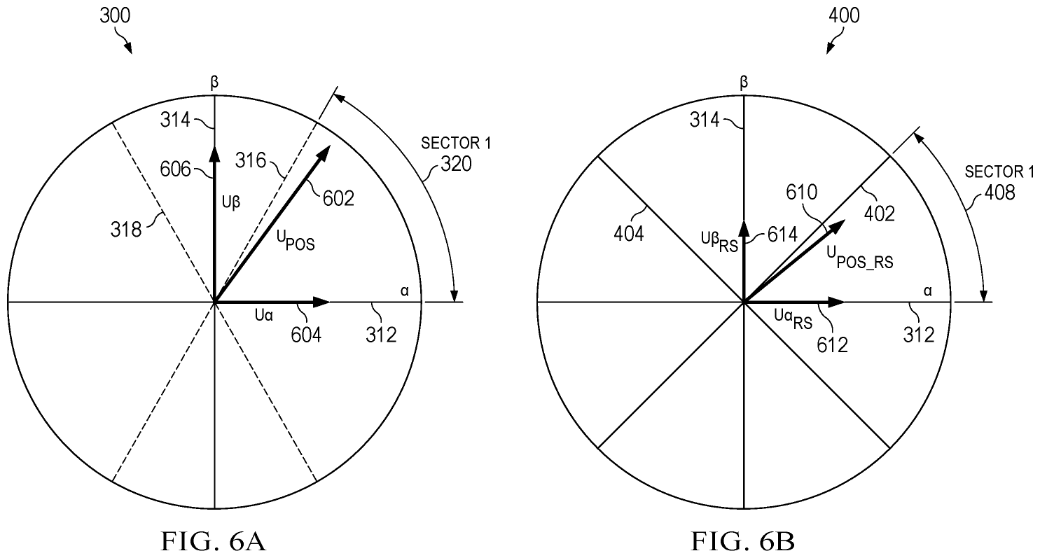

Following the rescaling described with respect to Equations 1 and 2, position vectors 301 between the 60° line 316 and an axis (the α axis 312 or the β axis 314) are located between the 45° line 402 and the same axis. Similarly, position vectors between the 120° line 318 and an axis are located between the 135° line 404 and the same axis. Position vectors aligned with the 60° line 316 or the 120° line 318 are rescaled to align with the 45° line 402 or the 135° line 404, respectively. (Arrows in FIG. 4 from the 60° line 316 to the 45° line 402, and from the 120° line 318 to the 135° line 404, indicate this correspondence.) Position vectors aligned with an axis remain aligned with the same axis. Also, rescaling does not change sign values (positive or negative) of coordinates. Accordingly, and as further described with respect to FIGS. 6A and 6B, determining a sector location of the position vector 301 within the sector layout 300 is equivalent to determining a sector location of a rescaled position vector within the sector layout 400.

FIGS. 6A and 6B illustrate an example of the rescaling described with respect to Equations 1 and 2. FIG. 6A is a first graph 600 of an example position vector (U_{POS}) 602 within the sector layout 300 of FIG. 3. FIG. 6B is a second graph 608 of the example position vector 602, rescaled to form a rescaled position vector (U_{POS_RS}) 610 within the sector layout 400 of FIG. 4.

The position vector 602 is represented by orthogonal components Uα 604 and Uβ 606. The example position vector 602 is selected so that it lies between the 45° line 402 (shown in FIG. 6B, not FIG. 6A) and the 60° line 316 (shown in FIG. 6A, not FIG. 6B).

The position vector 602 is rescaled using Equations 1 and 2 to form the rescaled position vector 610. Rescaling the position vector 602 corresponds to applying Equation 1 to Uα 604 to form a rescaled α component Uα_{RS} 612, and applying Equation 2 to Uβ 606 to form a rescaled β component Uβ_{RS} 614. Rescaling the position vector 602 using Equations 1 and 2 also rescales the 60° line 316 to correspond to the 45° line 402, and rescales the 120° line 318 to correspond to the 135° line 404. Also, the six-sector sector layout 300 of FIG. 3 is rescaled to correspond to the sixteen-sector sector layout 400 of FIG. 4. Note that the position vector 602 is located within sector 1 320 in the sector layout 300, and the rescaled position vector 610 is located within sector 1 408 in the sector layout 400.

Accordingly, determining a sector within the sector layout 300 that corresponds to the position vector 602 is equivalent to determining a sector within the sector layout 400 that corresponds to the rescaled position vector 610. This enables a sector within the sector layout 400 this is determined with respect to the rescaled position vector 610 to be mapped to a sector within the sector layout 300 corresponding to the position vector 602. Once it is determined that the rescaled position vector 610 is located within sector 1 408, a mapping function (such as a memory access or computation) may be applied to determine that the position vector 602 is located within sector 1 320. Determining a sector within the sector layout 400 can be performed using comparisons as shown in Table 1, or using other comparisons, as described herein. In some examples, these comparisons can be implemented in hardware, which may provide benefits such as increased speed, reduced power, and/or reduced device footprint.

In some examples, mapping correspondences between a first sector layout (such as the sector layout 400) and a second sector layout (such as the sector layout 300) can be stored within a lookup table, registers, or other memory, or encoded in hardware, or otherwise determined using hardware, software, or a combination of hardware and software.

Returning to FIG. 5, as shown by the graph 500, the sector location of a position vector can be determined by determining the truth values of the comparisons Uα+Uβ>0, Uα−Uβ>0, and Uβ>0. These comparisons are similar to the comparisons used to generate Table 1, and are sufficient to distinguish the six sectors of the sector layout 300 after rescaling as described above. In some examples, the comparisons Uα+Uβ>0 and Uα−Uβ>0 are equivalent to comparing a magnitude of the Uα vector 302 to a magnitude of the Uβ vector 304.

For example, consider Sector 1 320. As shown in FIG. 5, following the rescaling transformation indicated by the arrows (as described above), rescaled sector 1 320 includes a span from 0° to 45°. In that span certain conditions are true, as shown outside the perimeter of the graph for that Section 1 320. Specifically, in rescaled Sector 1 320, Uα+Uβ>0 (from 0° to) 135°, Uα−Uβ>0 (from 225° to) 45°, and Uβ>0 (from 0° to 180°). Corresponding observations may be made in the other sectors. In rescaled sector 2 322, Uα+Uβ>0, Uα−Uβ<0, and Uβ>0. In rescaled sector 3 324, Uα+Uβ<0, Uα−Uβ<0, and Uβ>0. In rescaled sector 4 326, Uα+Uβ<0, Uα−Uβ<0, and Uβ<0. In rescaled sector 5 328, Uα+Uβ<0, Uα−Uβ>0, and Uβ<0. In rescaled sector 6 330, Uα+Uβ>0, Uα−Uβ>0, and Uβ<0.

In some examples, the name zero sector refers to a zero force vector applied to a rotor within zero sectors, and corresponds to portions of a sinusoidal output waveform that control vectors (such as Tₐ 306, T_{b} 308, and T_{c} 310) that are designed to induce that are intended to have a zero derivative. Zero sectors are further described with respect to FIG. 6. In some examples, sector 0 406 corresponds to sector 1 320, and sector 8 422 corresponds to sector 4 326. In some examples, sector correspondences are different than described herein. In some examples, different demarcation lines (at different angles from the α axis 212 or from another reference) can be used than those described herein.

In an example using the 60° line 316 and the 120° line 318 as sector demarcating lines, a first zero sector corresponds to sector 0 406 (see FIG. 4), sector 1 320 corresponds to sectors 1 and 2 (408 and 410), sector 2 322 corresponds to sectors 3, 4, and 5 (412, 414, and 416), sector 3 324 corresponds to sectors 6 and 7 (418 and 420), a second zero sector corresponds to sector 8 422, sector 4 326 corresponds to sectors 9 and 10 (424 and 426), sector 5 328 corresponds to sectors 11, 12, and 13 (428, 430, and 432), and sector 6 330 corresponds to sectors 14 and 15 (434 and 436). In some examples, the flags included in TDM are compared to a table to make this correspondence.

In some examples corresponding to the sector layout 300 of FIG. 3, in sectors 1 and 4 (320 and 326), Tₐ=Uα×\sqrt{3/2}+Uβ/2, T_{b}=−Uα×v3/2+Uβ×3/2, and T_{c}=−Uα×\sqrt{3/2}−Uβ/2. In sectors 2 and 5 (322 and 328), Tₐ=Uα×\sqrt{3}, T_{b}=Uβ, and T_{c}=−Uβ. And in sectors 3 and 6 (324 and 330), Tₐ=Uα×\sqrt{3/2}−Uβ/2, T_{b}=−Uα×\sqrt{3/2}+Uβ/2, and T_{c}=−Uα×\sqrt{3/2}−Uβ×3/2.

In some examples, fewer or more demarcation lines are used to enable different sector correspondences. For example, in addition to the 60° line 316 and the 120° line 318, a 30° line and a 150° line (not shown) can also be used, enabling use of the QUADF instruction to determine location of a position vector 301 within any of twelve sectors (or twenty-four sectors, if demarcation lines are counted as sectors). For example, the QUADF instruction can be called after rescaling the 60° line 316 and the 120° line 318 to obtain a first TDM result, and then the QUADF instruction can be called a second time after rescaling the 30° line and the 150° line to obtain a second TDM result. The two TDM results can be compared to determine which of twelve sectors the position vector 301 is located in.

FIG. 7 is an example control system 700 for the three phase inverter 206 of FIG. 2. The control system includes a voltage source 702 such as the DC power supply 204, a first n-channel insulated gate bipolar transistor (IGBT) (IGB1) 704, a second n-channel IGBT (IGB2) 706, a third n-channel IGBT (IGB3) 708, a fourth n-channel IGBT (IGB4) 710, a fifth n-channel MOSFET (IGB5) 712, and a sixth n-channel MOSFET (IGB6) 714. In some examples, silicon carbide or gallium nitride transistors can be used instead of IGBTs. In some examples, IGBTs can be manufactured to operate as high voltage switches, for example, in a 400 volt to 800 volt range.

A positive terminal of the voltage source 702 is connected to collectors and cathodes of body diodes of IGB1 704, IGB2 706, and IGB3 708. A negative terminal of the voltage source 702 is connected to emitters and anodes of body diodes of IGB4 710, IGB5 712, and IGB6 714. A first output (output A) of the control system 700 is connected to an emitter and an anode of a body diode of IGB1 704, and to a collector and a cathode of a body diode of IGB4 710. A second output (output B) of the control system 700 is connected to an emitter and an anode of a body diode of IGB2 706, and to a collector and a cathode of a body diode of MN5 712. And a third output (output C) of the control system 700 is connected to an emitter and an anode of a body diode of IGB3 708, and to a collector and a cathode of a body diode of IGB6 714.

A gate of IGB1 704 receives a control signal Control1. A gate of IGB4 710 receives a control signal/Control1, which is a logical opposite of Control1, so that when IGB1 704 turns on IGB4 710 turns off, and when IGB1 704 turns off, IGB4 710 turns on. A gate of IGB2 706 receives a control signal Control2, and a gate of IGB5 712 receives a control signal/Control2, which is the logical opposite of Control2. A gate of IGB3 708 receives a control signal Control3, and a gate of IGB6 714 receives/Control3, which is the logical opposite of Control3.

In some examples, in response to the position vector 301 being determined to be in sector 1 320, IGB1 704 is turned on, IGB2 706 is turned off, IGB3 708 is turned off, IGB4 710 is turned off, IGB5 712 is turned on, and IGB6 714 is turned on. In response to the position vector 301 being determined to be in sector 2 322, IGB1 704 is turned on, IGB2 706 is turned on, IGB3 708 is turned off, IGB4 710 is turned off, IGB5 712 is turned off, and IGB6 714 is turned on. In response to the position vector 301 being determined to be in sector 3 324, IGB1 704 is turned off, IGB2 706 is turned on, IGB3 708 is turned off, IGB4 710 is turned on, IGB5 712 is turned off, and IGB6 714 is turned on.

In response to the position vector 301 being determined to be in sector 4 326, IGB1 704 is turned off, IGB2 706 is turned on, IGB3 708 is turned on, IGB4 710 is turned on, IGB5 712 is turned off, and IGB6 714 is turned off. In response to the position vector 301 being determined to be in sector 5 328, IGB1 704 is turned off, IGB2 706 is turned off, IGB3 708 is turned on, IGB4 710 is turned on, IGB5 712 is turned on, and IGB6 714 is turned off. And in response to the position vector 301 being determined to be in sector 6 330, IGB1 704 is turned on, IGB2 706 is turned off, IGB3 708 is turned on, IGB4 710 is turned off, IGB5 712 is turned on, and IGB6 714 is turned off.

In response to the position vector 301 being in the first zero sector, IGB1 704 is turned on, IGB2 706 is turned on, IGB3 708 is turned on, IGB4 710 is turned off, IGB5 712 is turned off, and IGB6 714 is turned off. In response to the position vector 301 being in the second zero sector, IGB1 704 is turned off, IGB2 706 is turned off, IGB3 708 is turned off, IGB4 710 is turned on, IGB5 712 is turned on, and IGB6 714 is turned on. In some examples, all switches on the positive terminal side being turned on or all switches on the negative terminal side being turned on corresponds to a zero net force vector applied to the rotor of the permanent magnet motor 208.

FIG. 8 is a process 800 for determining an arctangent of a position vector 301. In step 802, receive an initial position vector (such as the position vector 301). The initial position vector corresponds to a sum of a first component in a first dimension, such as the Uα vector 302, and a second component in a second dimension, such as the Uβ vector 304. In step 804, rotate the initial position vector by a rotation angle in response to the position vector being outside a selected range, the rotation angle selected to rotate the position vector into the selected range, to provide a processed position vector that may or may not be rotated with respect to the initial position vector (for example, a position vector that has an x dimension component that equals zero or a y dimension component that equals zero may not be rotated).

In some examples, step 804 corresponds to either of the following two cases. First, rotating a position vector 301 by −90° if the position vector 301 is located in sector 3, 4, 5, 11, 12, or 13. In some examples, the first case rotation is accomplished by multiplying the Uα vector 302 by negative one (in some examples, if the Uα vector 302 is not zero) and swapping the inverted Uα vector 302 with the Uβ vector 304. Or second, rotating the position vector 301 by 180° (or −180°) if the position vector is in sector 6, 7, 8, 9, or 10. In some examples, the second case rotation is accomplished by dividing the Uβ vector 304 by the Uα vector 302 (i.e., determining the ratio to be used as the input for the arctangent operation). Recall that in some examples, the output of the arctangent operation cannot tell the difference between position vectors 301 in certain sectors, such as between sector 1 408 and sector 9 424, or between sector 15 436 and sector 7 420. Also note that the second case rotation is applied if appropriate after the first case rotation is applied.

In some examples, the initial position vector may be rotated by the first case by an angle other than −90°. In some examples, the selected range is other than −45° to 45°.

In step 806, determine an arctangent of the processed position vector to provide an arctangent output angle. In some examples, the process 800 enables step 806 to be performed using an arctangent instruction with a relatively narrow input range for which the arctangent instruction produces an accurate output, while enabling use of an arctangent instruction such as atan( ) that can be processed relatively rapidly (e.g., compared to other arctangent instructions, such as an atan 2( ) instruction).

In step 808, subtract the rotation angle from the arctangent output angle in response to the processed position vector being rotated with respect to the initial position vector, to provide a result angle that may or may not be different from the arctangent output angle. In some examples, a unit of the rotation angle used in step 808 (for example, unitless) is different from a unit used in step 804 (for example, degrees or radians). In some examples, an Mz value determined by a QUADF instruction (as described above) is an example of a rotation angle value usable in step 808 for an arctangent instruction (step 806) that returns a per-unit arctangent result. A per-unit arctangent result is normalized so that a full circle corresponds to a −1 to 1 angle range. In some examples, the Mz value is the opposite (negative) of the rotation angle applied by a first case rotation and/or a second case rotation applied by step 804.

In some examples, steps 806 and 808 are performed responsive to a single instruction. In some examples, steps 806 and 808 are performed responsive to multiple instructions, such as separate instructions for steps 806 and 808.

FIG. 9 is a process 900 for determining a sector corresponding to a position vector 301. In step 902, receive a position vector 301 corresponding to a sum of a first component in a first dimension and a second component in a second dimension. In some examples, the first component is the Uα vector 302 and the second component is the Uβ vector 304. In step 904, receive a first set of sector demarcation lines corresponding to a first sector layout, such as the 60° line 316 and the 120° line 318.

In step 906, receive a second set of sector demarcation lines corresponding to a second sector layout, such as the 45° line 402 and the 135° line 404. In some examples, the second set of sector demarcation lines includes a line for which the first dimension equals the second dimension (for example, x=y or α=β), and a line for which the first dimension equals an opposite (negative) of the second dimension (for example, x=−y or α=−β). In some examples, the second sector layout corresponds to the sector layout 400.

In step 908, rescale the first component and the second component in response to the first set of sector demarcation lines and the second set of sector demarcation lines, to provide a rescaled position vector corresponding to a sum of a first rescaled component and a second rescaled component. In some examples, this rescaling is performed as shown in and described with respect to Equations 1 and 2. In step 910, compare a magnitude of the first rescaled component to a magnitude of the second rescaled component, and compare the first rescaled component or the second rescaled component to zero.

In step 912, determine an intermediate sector of the rescaled position vector in response to the compare actions and the second sector layout. In step 814, convert the intermediate sector from the second sector layout to the first sector layout to provide a result sector.

Modifications are possible in the described examples, and other examples are possible within the scope of the claims.

In some examples, the processor 106 is a central processing unit (CPU), a digital signal processor (DSP), or a microcontroller.

In some examples, one or more of the functional blocks described with respect to the FOC control circuit 202 are performed using software instructions stored in a memory and executed on a processor.

In some examples, one or more of the functional blocks described with respect to the FOC control circuit 202 are performed using specialized hardware.

In some examples, methods or processes described herein are performed using software, hardware, or a combination of software and hardware.

In some examples, a motor other than a permanent magnet motor is used, such as an induction motor.

In some examples, some or all of the FOC control circuit 202 is fabricated on an IC such as the IC 102.

In some examples, a QUADF instruction is used with an arctangent instruction other than puatan( ) such as an arctangent instruction with a different range or that returns values in degrees or radians. In some examples, Mz values are determined according to a selected range and unit used by a corresponding arctangent instruction.

In some examples, a voltage regulator other than a three phase inverter 206 is used to provide power to the permanent magnet motor 208 (or other target of a rotational system 104). In some examples, a power supply other than a DC power supply 204 is used to provide power to the voltage regulator used to power the permanent magnet motor 208.

The term “couple,” as used in the specification, may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

In this description, the term “and/or” (when used in a form such as A, B and/or C) refers to any combination or subset of A, B, C, such as: (a) A alone; (b) B alone; (c) C alone; (d) A with B; I A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin”, “ball” and “lead” are used interchangeably. Unless specifically stated to the contrary, these terms are generally used to mean an interconnection between or a terminus of a device element, a circuit element, an IC, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

While certain elements of the described examples may be included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

What is claimed is:

1. A device comprising:
a non-transitory memory configured to store a first instruction; and
a processor configured to receive the first instruction from the memory and to, in response to the first instruction:
receive a position vector corresponding to a sum of a first component in a first dimension and a second component in a second dimension;
compare a magnitude of the first component to a magnitude of the second component, and compare the first component or the second component to zero; and
determine a sector in which the position vector is located responsive to the compare actions.

2. The device of claim 1,
wherein the memory is configured to store additional instructions; and
wherein the processor is configured to receive the additional instructions from the memory and to, in response to the additional instructions, operate a rotational system in response to the sector.

3. The device of claim 1,
wherein the determine a sector action is performed responsive to a sector layout; and
wherein the sector layout corresponds to an axis in the first dimension, a first demarcation line, and a second demarcation line.

4. The device of claim 3,
wherein the sector layout is a first sector layout;
wherein the memory is configured to store additional instructions; and
wherein the processor is configured to receive the additional instructions from the memory and to, in response to the additional instructions:
prior to the receive action, in response to the first sector layout and a second sector layout, rescale the position vector to provide a first rescaled component and a second rescaled component, the second sector layout corresponding to the axis, a third demarcation line, and a fourth demarcation line; and
when executing the first instruction, use the first rescaled component as the first component and use the second rescaled component as the second component.

5. The device of claim 4, wherein the processor is configured to, in response to the additional instructions, perform the rescaling action by dividing the first component by a sine of an angle between the third demarcation line and the axis, and by dividing the second component by a cosine of the angle between the third demarcation line and the axis.

6. The device of claim 1,
wherein the position vector is an initial position vector; and
wherein the processor is configured to, in response to the first instruction, rotate the initial position vector by a rotation angle in response to the position vector being outside a selected range, the rotation angle selected to rotate the position vector into the selected range, to provide a processed position vector.

7. The device of claim 6,
wherein the memory is configured to store additional instructions; and
wherein the processor is configured to receive the additional instructions from the memory and to, in response to one or more of the additional instructions:
determine an arctangent of the processed position vector to provide an arctangent output angle; and
subtract the rotation angle from the arctangent output angle in response to the processed position vector being rotated with respect to the initial position vector, to provide a result angle.

8. A controlled system comprising:
a rotational system;
a non-transitory memory configured to store a first instruction and a second instruction; and
a processor configured to receive the first instruction from the memory and to, in response to the first instruction:
receive a position vector corresponding to a sum of a first component in a first dimension and a second component in a second dimension;
compare a magnitude of the first component to a magnitude of the second component, and compare the first component or the second component to zero; and
determine a sector in which the position vector is located responsive to the compare actions;
wherein the processor is configured to receive the second instruction from the memory and to, in response to the second instruction, control the rotational system based on the sector.

9. The system of claim 8,
wherein the determine a sector action is performed responsive to a sector layout; and
wherein the sector layout corresponds to an axis in the first dimension, a first demarcation line, and a second demarcation line.

10. The system of claim 9,
wherein the sector layout is a first sector layout;
wherein the memory is configured to store additional instructions; and
wherein the processor is configured to receive the additional instructions from the memory and to, in response to the additional instructions:
prior to the receive action, in response to the first sector layout and a second sector layout, rescale the position vector to provide a first rescaled component and a second rescaled component, the second sector layout corresponding to the axis, a third demarcation line, and a fourth demarcation line; and
when executing the first instruction, use the first rescaled component as the first component and use the second rescaled component as the second component.

11. The system of claim 10, wherein the processor is configured to, in response to the additional instructions, perform the rescaling action by dividing the first component by a sine of an angle between the third demarcation line and the axis, and by dividing the second component by a cosine of the angle between the third demarcation line and the axis.

12. The system of claim 8,
wherein the position vector is an initial position vector; and
wherein the processor is configured to, in response to the first instruction, rotate the initial position vector by a rotation angle in response to the position vector being outside a selected range, the rotation angle selected to rotate the position vector into the selected range, to provide a processed position vector.

13. The system of claim 12,
wherein the memory is configured to store additional instructions; and
wherein the processor is configured to receive the additional instructions from the memory and to, in response to one or more of the additional instructions:
determine an arctangent of the processed position vector to provide an arctangent output angle; and
subtract the rotation angle from the arctangent output angle in response to the processed position vector being rotated with respect to the initial position vector, to provide a result angle.

14. A method comprising:
receiving an initial position vector corresponding to a sum of a first initial component in a first dimension and a second initial component in a second dimension, so that the initial position vector is scaled according to a first sector layout;
receiving a second sector layout;
rescaling the first initial component and the second initial component in response to the first sector layout and the second sector layout, to provide a rescaled position vector corresponding to a sum of a first rescaled component and a second rescaled component, so that the rescaled position vector is scaled according to the second sector layout;
comparing a magnitude of the first rescaled component to a magnitude of the second rescaled component, and compare the first rescaled component or the second rescaled component to zero;
determining an intermediate sector of the rescaled position vector in response to the compare actions and the second sector layout; and
converting the intermediate sector from the second sector layout to the first sector layout to provide a result sector.

15. The method of claim 14, further comprising operating a rotational system in response to the result sector.

16. The method of claim 14, wherein the first sector layout corresponds to a first set of demarcation lines, and the second sector layout corresponds to a second set of demarcation lines.

17. The method of claim 16,
wherein the first set of demarcation lines corresponds to an axis in the first dimension, a first demarcation line, and a second demarcation line; and
wherein the second set of demarcation lines corresponds to the axis in the first dimension, a third demarcation line, and a fourth demarcation line.

18. The method of claim 17, wherein the rescaling is performed by dividing the first initial component by a sine of an angle between the third demarcation line and the axis, and by dividing the second initial component by a cosine of the angle between the third demarcation line and the axis.

19. The method of claim 14, further comprising rotating the initial position vector by a rotation angle in response to the initial position vector being outside a selected range, the rotation angle selected to rotate the initial position vector into the selected range, to provide a processed position vector.

20. The method of claim 19, further comprising:
determining an arctangent of the processed position vector to provide an arctangent output angle; and
subtracting the rotation angle from the arctangent output angle in response to the processed position vector being rotated with respect to the initial position vector, to provide a result angle.
